(19) United States
(12) Patent Application Publication
(10) Pub. No.: US 2011/0303094 A1
(43) Pub. Date: Dec. 15, 2011

(54) COFFEE MAKER

(76) Inventor: John M. Lown, Huntington Beach, CA (US)

(21) Appl. No.: 12/816,193

(22) Filed: Jun. 15, 2010

(51) Int. Cl. A47J 31/06

(52) U.S. Cl. 99/299

(57) ABSTRACT

A coffee maker assembly is provided including a reservoir container including a reservoir opening defined by an upper rim providing access to a reservoir and at least one aperture defined on a surface thereof. The assembly also includes a release valve including a valve seal that rests in a hollow seal holder positioned concentric with the aperture. The release valve is rotatable between a first position in which the valve seal is in sealing contact with the aperture and a second position in which the valve seal is not in sealing contact with the aperture. The coffee maker assembly may be coupled to a jug or pot to create a coffee making system

### BACKGROUND

The present disclosure is related to drip style coffee makers.

Presently, various methods exist for preparing coffee. For example, drip style coffee makers provide a relatively simple and convenient means for allowing coffee to be brewed.

However, some drip style coffee making methods have drawbacks. For example, in a regular pour over manual drip coffee maker, the strength of the coffee is determined by how fast the hot water is poured over the grounds. Thus, the user is not able to “walk-away” from the coffee maker while the coffee is brewing.

In a French press coffee drip coffee making machine, the coffee must be allowed to soak. After soaking, a grind is pressed against the coffee grounds to press the hot water through the grounds after brewing is complete. Unfortunately, French press coffee makers are not as convenient as drip coffee makers due to preparation time and cleaning time. The French press also loses heat faster than some other methods.

### SUMMARY

In one aspect, a coffee maker assembly is provided including a reservoir container including a reservoir opening defined by an upper rim providing access to a reservoir and at least one aperture defined on a surface thereof. The assembly also includes a release valve including a valve seal that rests in a hollow seal holder positioned concentric with the aperture. The release valve is rotatable between a first position in which the valve seal is in sealing contact with the aperture and a second position in which the valve seal is not in sealing contact with the aperture.

In another aspect, a coffee making system is provided including a jug including a container body and a cap assembly used to secure the contents within the container body. The system also includes a coffee maker assembly including a reservoir container including a reservoir opening defined by an upper rim providing access to a reservoir and at least one aperture defined on a surface thereof; a release valve including a valve seal that rests in a hollow seal holder positioned concentric with the aperture, the release valve rotatable between a first position in which the valve seal is in sealing contact with the aperture and a second position in which the valve seal is not in sealing contact with the aperture; and a valve housing including a cam portion having a cam formed on a surface of the cam portion. The release valve includes a follower formed on a surface of the release valve that is made to follow along the cam to cause the valve seal to move between the first position and the second position. The system also includes a fixed portion including a sidewall that defines a well that extends the length of the sidewall and wherein the well defines a well opening and is sized and shaped to receive and mount the release valve operably nested with the cam portion over the well opening; and a valve adapter configured to releasably attach the coffee maker assembly to a rim of the cap assembly.

This brief summary has been provided so that the nature of this disclosure may be understood quickly. A more complete understanding of the disclosure can be obtained by reference to the following detailed description of the various embodiments thereof in connection with the attached drawings.

### BRIEF DESCRIPTION OF THE DRAWINGS

The foregoing features and other features of the present disclosure will now be described with reference to the drawings of an illustrated embodiment. In the drawings, the same components have the same reference numerals. The illustrated embodiment is intended to illustrate, but not to limit the disclosure. The drawings include the following Figures:

FIG. 1 is a perspective view of a drip coffee maker system in accordance with an embodiment;

FIG. 2 is an exploded view of a coffee maker assembly in accordance with an embodiment;

FIG. 3 is a simplified cross-sectional view of a reservoir container including a filter member in accordance with an embodiment;

FIG. 4A is a cut away cross sectional view of a portion of the coffee maker assembly in accordance with an embodiment;

FIG. 4B is a side view of a portion of the coffee maker assembly in accordance with an embodiment;

FIG. 5A is a simplified top view of the rim of the cap assembly in accordance with an embodiment;

FIG. 5B is a simplified bottom view of a valve adapter in accordance with an embodiment; and

FIGS. 6A and 6B are cross sectional views of the coffee maker assembly shown in a closed and in an open position, respectively, in accordance with an embodiment.

### DETAILED DESCRIPTION

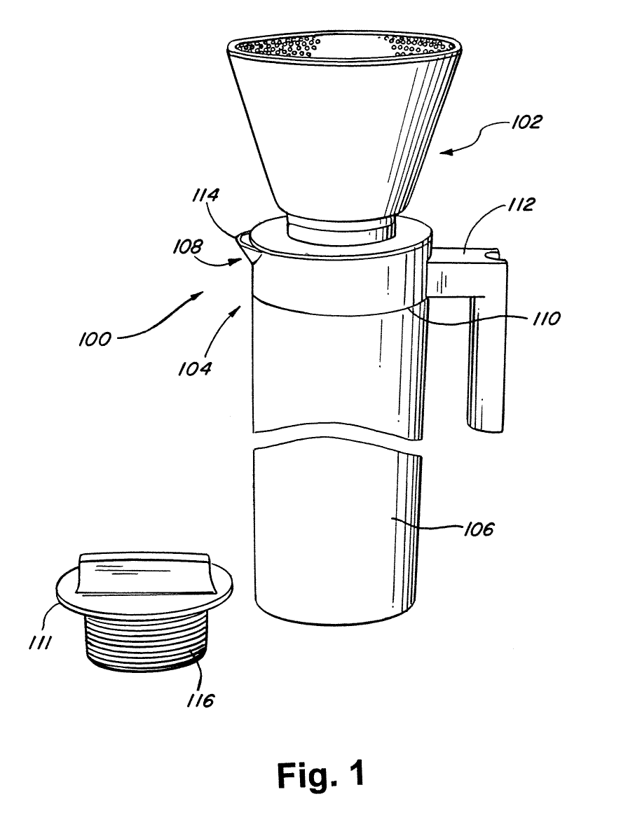

FIG. 1 is a perspective view of a coffee maker system 100 in accordance with an embodiment. In this embodiment, the coffee maker system 100 may be a drip style coffee making system, which includes a coffee maker assembly 102 operably coupled to a pot or jug 104. In this embodiment, the pot or jug 104 includes a container body 106 and a cap assembly 108 used to secure the contents within the container body 106.

The container body 106 may be made of any suitable material that allows for the storage of hot or cold liquids. In some embodiments, the container body 106 may be made of a glass, a plastic, a metal or metal alloy, and the like. The glass container body, for example, may be made of any suitable type of glass, such as silicon dioxide. Pyrex, lead crystal and the like. The metal container body, for example, may be made of any suitable type of metal, such as aluminum, stainless steel, suitable alloys of any suitable metals and the like. The container body 106 may be designed to any desired volume. For example, the container body 106 may be designed to hold from about 4 ounces to about 64 ounces.

The container body 106 includes an opening (not shown) configured for receiving and retaining the cap assembly 108. The cap assembly 108 includes a rim 110 and an associated cap member 111 (shown separate from the cap assembly 108 in FIG. 1). The rim 110 has a handle member 112 attached or formed to one side thereof and a pouring spout 114 attached or formed on the other side opposed thereto. The rim 110 defines an opening having a predetermined diameter. The rim 110 is configured for being removably associated with the container body 106. For example, the rim 110 may include internal threads (not shown) that may be screwed onto threads (not shown) formed adjacent and around a neck formed at the opening on the container body 106. In other embodiment, the rim 110 of the cap assembly 108 may be made to “snap” on to the container body 106. The cap member 111 may include external threads 116 that may also be threaded onto internal threads of the rim 110 to secure the cap member 111 onto the rim 110 and thus the container body 106.

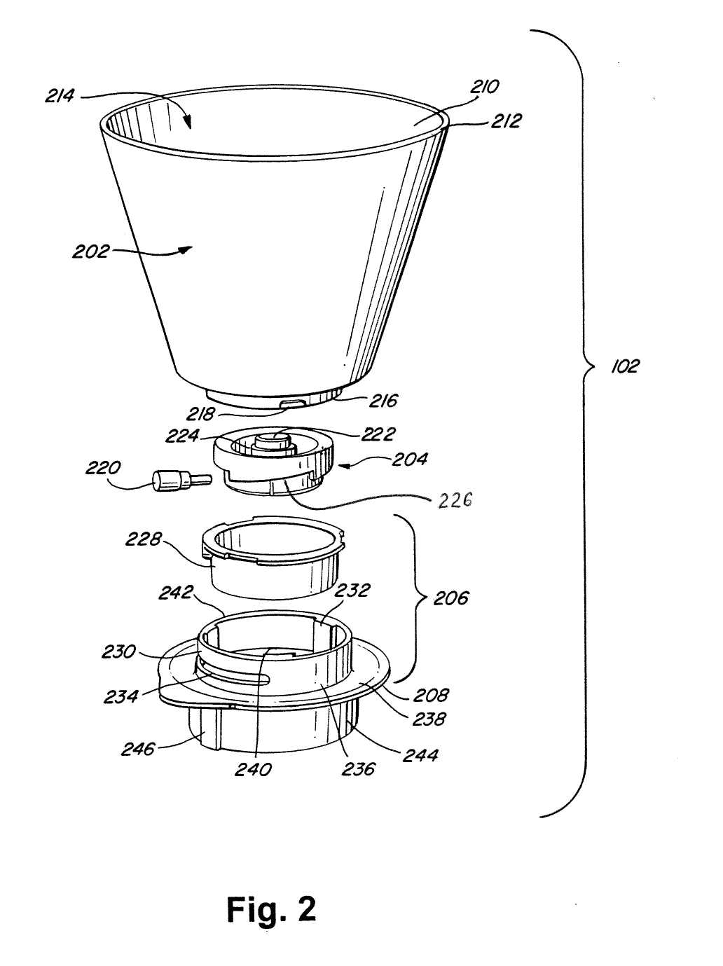

FIG. 2 is an exploded view of the coffee maker assembly 102 in accordance with an embodiment. The coffee maker assembly 102 includes a reservoir container 202, a rotatable liquid release valve 204, a valve housing 206 and a valve adapter 208, which is configured to lock the coffee maker assembly 102 into the rim 110 of the cap assembly 108 as described below.

The reservoir container 202 includes an opening 210 defined by an upper rim 212. The opening 210 provides access to a hollow reservoir 214 into which hot or cold fluid, such as water, may be poured and used to brew a coffee drink. In one embodiment, the reservoir container 202 includes a mating collar 216 formed on the external bottom surface of the reservoir container 202, which may include a tab 218 or similar feature configured to mate with a corresponding detent or similar feature (not shown) on the valve housing 206 to allow the reservoir container 202 to be releasably coupled to the valve housing 206.

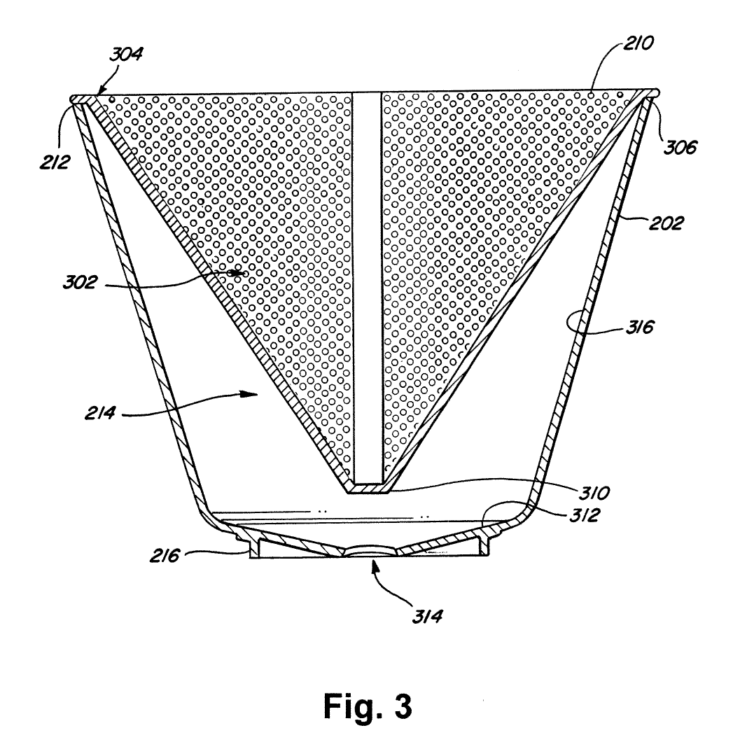

As shown in FIG. 3, the reservoir container 202 may be configured to mate with, and house a basket-like member or filter member 302. In this embodiment, the filter member 302 is sized and shaped to fit into opening 210. A top end 304 of the filter member 302 includes a lip portion 306 that seats on, and mates with the upper rim 212 of the reservoir container 202. When seated on the upper rim 212, a bottom end 310 of the filter member 302 extends into the reservoir container 202 to a predetermined height above a bottom surface 312 of the reservoir container 202. In some embodiments, the bottom end 310 may contact some portion of the bottom surface 312. The bottom surface 312 may be tapered and may include at least one aperture 314 formed through the bottom surface 312 for allowing liquid to pass therethrough.

In one embodiment, the filter member 302 may be a cone shaped reusable mesh filter into which coffee grounds may be placed to allow for steeping or brewing. Alternatively, the filter member 302 is configured to hold a separate filter, such as a standard sized paper filter.

In one embodiment, when positioned in the reservoir container 202, aside from the mating of the lip portion 306 with the upper rim 212, the cone shaped filter member does not contact side walls 316 or the bottom surface 312 of the reservoir container 202. This configuration may be described herein as the filter member 302 “floating” in the reservoir 214. Housing the floating filter member 302 concentrically within the reservoir container 202 in this manner allows more of the coffee placed into the filter member to have contact with the water being held in the reservoir 214 during steeping or brewing, while reducing the overall profile size of the coffee maker assembly 102 relative to drip coffee makers having a similar capacity. It should be understood that the filter member is not limited to being a cone shaped filter and may have any suitable geometry, which allows the filter member to be seated on the upper rim 212 of the reservoir container while the remainder of the filter member 302 is allowed to float within the reservoir 214 by having no contact with the internal surface of the reservoir container 202. It should be understood that in some embodiment, some contact may be made between the filter member and the internal surface of the reservoir container 202.

Referring again to FIG. 2, the release valve 204 includes a soft, pliable diaphragm or valve seal 222 that rests in a hollow seal holder 224. The valve seal 222 is positioned concentric with a central axis of the release valve 204. In one embodiment, the position of the valve seal 222 corresponds with, and is concentric with the aperture 314 defined on the bottom surface of the reservoir container 202. In operation, the valve seal 222 is made to mate with and seal the aperture 314. The release valve 204 also includes a follower 226 formed along an external surface of the release valve 204. In operation, as further described below, the follower 226 is made to follow along a cam formed in the valve housing 206 to cause the valve seal 222 to move into, and out from, mating contact with the aperture 314 to open and close the aperture.

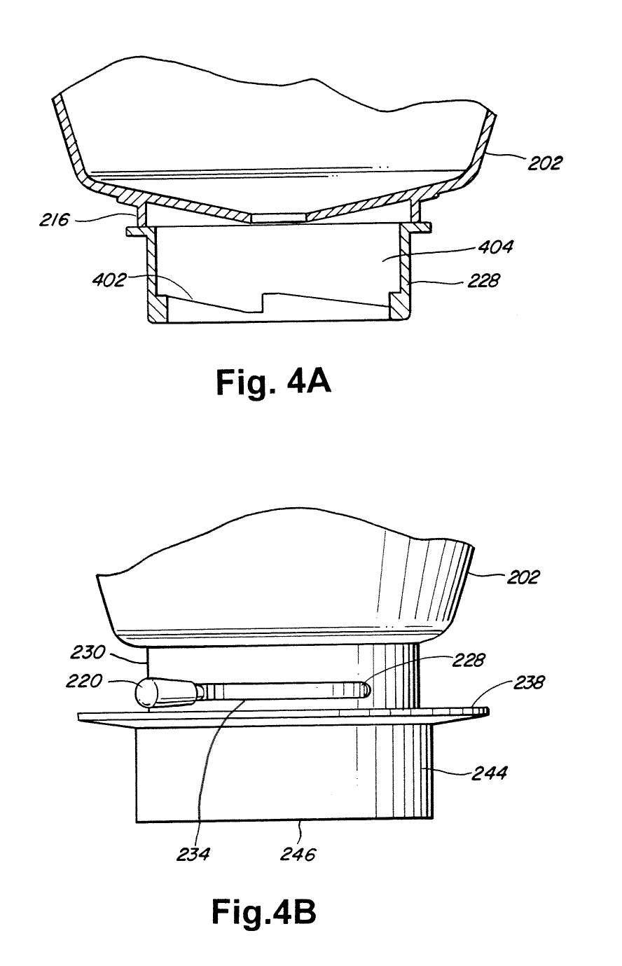

In one embodiment, the valve housing 206 includes two components: a cam portion 228 and a fixed portion 230. During operation of the coffee maker assembly the release valve 204 is positioned within the cam portion 228 and is operable to rotate within the cam portion. As shown in FIG. 4A, the cam portion 228 includes a cam 402 formed on the internal surface 404 of the cam portion 228. Once seated in the cam portion 228, the cam 402 is configured to mate with the follower 226 (FIG. 2) formed on the release valve 206. The rotation of the release valve 204 within the cam portion 228 causes the follower 226 to follow along the cam 402 and move in to, and out from, mating contact with the aperture 314.

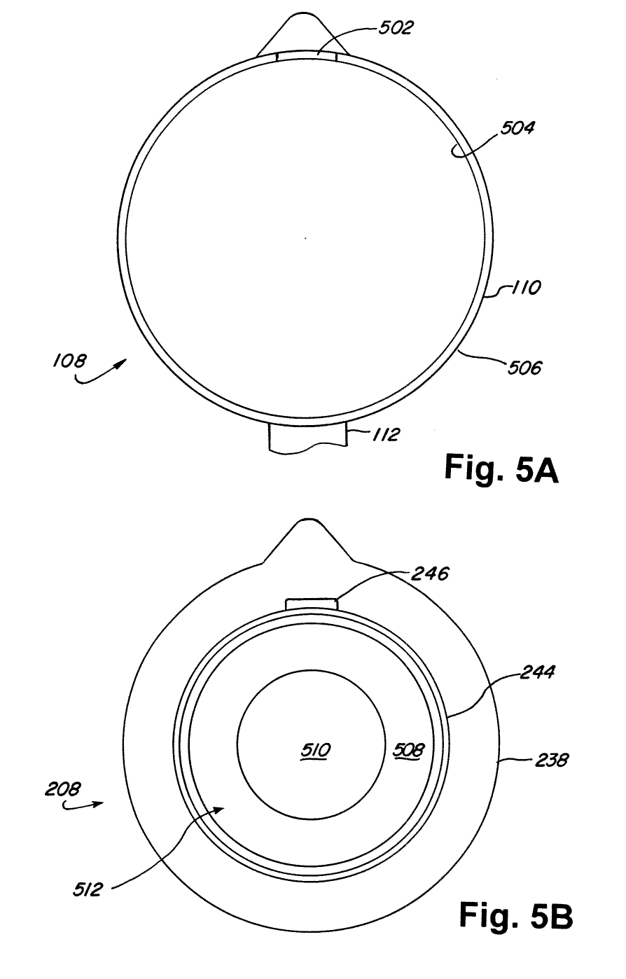

The fixed portion 230 is generally cylindrically shaped and includes side wall 236 that extends from a flange 238 of the valve adapter 208. The fixed portion 230 is formed into the valve adapter 208 such that a well or open space 240 is defined that extends the length of the side wall 236 above and below the flange 238 to a floor 508 (FIG. 5B) of the well 240 that defines an opening 510 (FIG. 5B). The well 240 is sized and shaped to receive and mount the release valve 204 operably positioned with the cam portion 228 over the opening 510. An upper rim 242 of the fixed portion 230 is mated against the reservoir container 202. The upper rim 242 has formed adjacent thereto at least one catch feature 232 that allows the fixed portion 230 to be releasably coupled to the reservoir container 202 through the interaction of the at least one tab 218 formed on the mating collar 216. When mated together, the well 240 of the fixed portion 230 provides a housing for the release valve 204 and the cam portion 228 positioned inside.

In one embodiment, as shown n FIG. 4B, the cam portion 228 may include a handle 220 that is attached to the cam portion 228 to facilitate the manipulation by a user of the relative rotation between the cam portion 228 and the release valve 204. The handle 220 may extend through a slot 234 defined on the fixed portion 230 to be attached to the cam portion 228. The slot 234 is sized and shaped to allow for movement of the handle 220 between a valve open position and a valve closed position as described below.

Referring again to FIG. 2, and with additional reference to FIG. 5B, the valve adapter 208 includes an open or hollow section 512 formed below the floor 508 of the well 240 and the opening 510. In one embodiment, the open section is defined by a generally cylindrical side wall 244 that extends below the flange 238. In one embodiment, the valve adapter 208 is configured to releasably mate with the rim 110 of cap assembly 108 to couple the coffee maker assembly 102 to the jug 106. In operation, the side wall 244 of valve adapter 208 is configured to be slidably positioned into the rim 110 in place of the cap member 111. As shown in FIGS. 5A and 5B, in one embodiment, the rim 110 includes a channel 502 formed into the side wall 504 of the rim 110. The channel 502 is sized and shaped to receive a rib member 246 formed on an external portion of the side wall 244. As the valve adapter 208 is engaged with the rim 110, the side wall 244 of the valve adapter 208 slides against the side wall 504 of the rim 110 while the rib member 246 slides into the channel 502. The flange 238 sits over the top surface 506 of the rim to provide a closure. When use of the coffee maker assembly is complete, the valve adapter 208 may be removed from the rim 110 by sliding the valve adapter out from the rim 110. The cap member 111 may then be inserted into the rim 110 to close the jug 106, if desired.

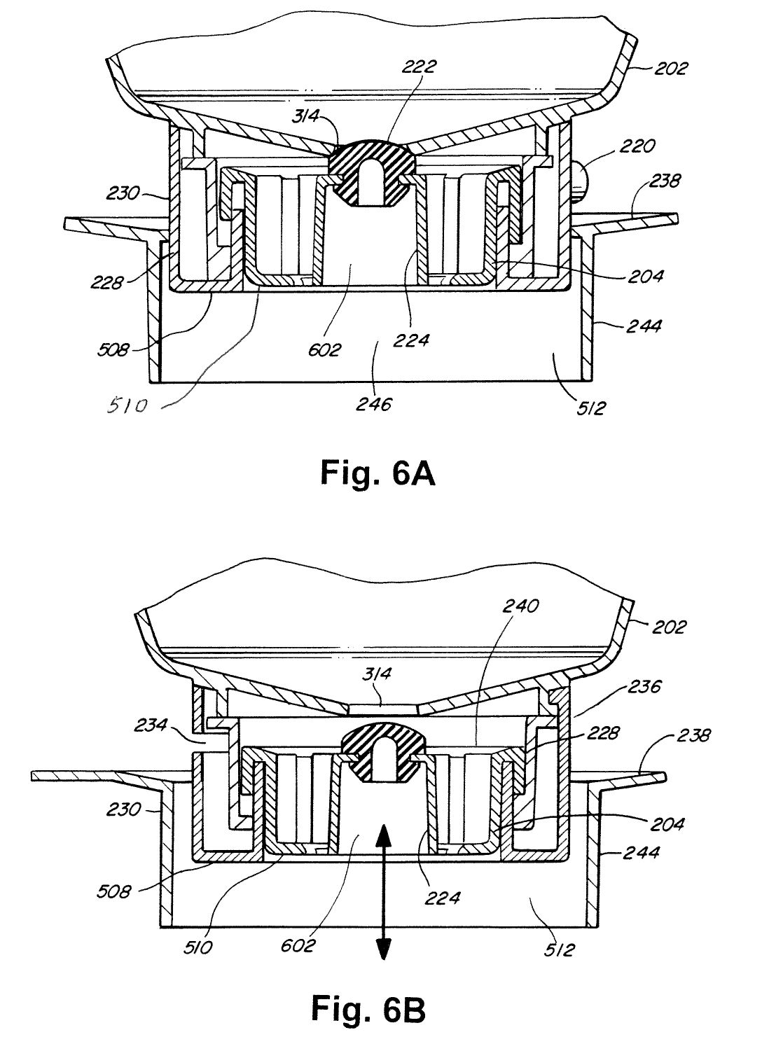

FIGS. 6A and 6B are cross sectional views of the coffee maker assembly 102 shown in a closed and in an open position, respectively, in accordance with an embodiment. As shown in FIG. 6A, once assembled, the reservoir container 202 is mated to the side wall 236 of the fixed portion 230 of the valve housing 206. The release valve 204 is operably nested into the cam portion 228. The nested components are mounted into the fixed portion 230 to seat over the opening 510 defined at the bottom of well 240. In the valve closed position, the cam 402 and the follower 226 are mated together such that the valve seal 222 is raised into contact with aperture 314 to seal closed the aperture 314. In this position, the valve seal 222 prevents fluid from communicating between the reservoir and the jug. Since fluid is not allowed to penetrate though the valve seal 222, in the closed position, the coffee maker assembly 102 may or may not be positioned into rim 110 during the brewing or steeping process.

As shown in FIG. 6B, to open the release valve 204, the handle 220 coupled to the cam portion 228 may be grasped by a user and made to rotate through the slot 234. The rotation of the cam portion 228 causes the follower 226 on the release valve 204 to follow along the cam 402 causing the valve seal 222 on the release valve 204 to move away from the aperture 314. A portion of the release valve 204 moves into the opening 510. By removing the valve seal 222 from the aperture 314 fluid held within the reservoir is allowed to flow from the reservoir through a hollow section 602 of the valve seal holder 224 and into the open section 512 of the valve adapter 208. The fluid then exits the valve adapter 208 and enters the container body 106 of the jug.

To return the coffee maker assembly 102 to the closed position, the handle 220 is rotated in a counter direction causing the cam of the release valve to follow along the follower 402 of the cam portion. The rotation of the handle causes the valve seal 222 to move toward and to contact the aperture 314 and seal the aperture 314.

Although the present disclosure has been described with reference to specific embodiments, these embodiments are illustrative only and not limiting. Many other applications and embodiments of the present disclosure will be apparent in light of this disclosure and the following claims.

What is claimed is:

1. A coffee maker assembly comprising:
a reservoir container including a reservoir opening defined by an upper rim providing access to a reservoir and at least one aperture defined on a surface thereof; and
a release valve including a valve seal that rests in a hollow seal holder positioned concentric with the aperture, the release valve rotatable between a first position in which the valve seal is in sealing contact with the aperture and a second position in which the valve seal is not in sealing contact with the aperture.

2. The assembly of claim 1 further comprising a valve housing including a cam portion having a cam formed on a surface of the cam portion, wherein the release valve includes a follower formed on a surface of the release valve that is made to follow along the cam to cause the valve seal to move between the first position and the second position, and a fixed portion.

3. The assembly of claim 2, wherein the cam portion includes a handle attached to the cam portion to facilitate the manipulation by a user of relative rotation between the cam portion and the release valve.

4. The assembly of claim 2, wherein the fixed portion includes a sidewall that defines a well that extends the length of the sidewall and wherein the well defines a well opening and is sized and shaped to receive and mount the release valve operably nested with the cam portion over the well opening.

5. The assembly of claim 1, further comprising a valve adapter configured to releasably attach the valve housing to a jug.

6. The assembly of claim 1, wherein the reservoir container is configured to receive and house a basket-like member.

7. The assembly of claim 6, wherein the basket-like member extends into the reservoir container to a predetermined height above the bottom surface of the reservoir container.

8. The assembly of claim 6, wherein the basket-like member comprises a cone shaped reusable mesh filter.

9. The assembly of claim 6, wherein the basket-like member comprises a lip portion configured to mate with the upper rim of the reservoir container, wherein remaining surfaces of the basket-like member are free form contact with an internal surface of the reservoir container.

10. The assembly of claim 1, wherein the coffee maker assembly is operably coupleable to a jug comprising a container body and a cap assembly used to secure the contents within the container body.

11. The assembly of claim 10, wherein the container body may be made of any suitable material that allows for the storage of hot or cold liquids.

12. The assembly of claim 11, wherein the suitable material comprises a glass, a plastic, a metal, a metal alloy and combinations thereof

13. The assembly of claim 10, wherein the container body comprise a volume capable of holding from about 4 ounces to about 64 ounces.

14. The assembly of claim 9, further comprising a valve adapter configured for mating with the cap assembly.

15. A coffee making system comprising:
a jug including a container body and a cap assembly used to secure the contents within the container body; and
a coffee maker assembly comprising:
a reservoir container including a reservoir opening defined by an upper rim providing access to a reservoir and at least one aperture defined on a surface thereof;
a release valve including a valve seal that rests in a hollow seal holder positioned concentric with the aperture, the release valve rotatable between a first position in which the valve seal is in sealing contact with the aperture and a second position in which the valve seal is not in sealing contact with the aperture;
a valve housing including a cam portion having a cam formed on a surface of the cam portion, wherein the release valve includes a follower formed on a surface of the release valve that is made to follow along the cam to cause the valve seal to move between the first position and the second position, and a fixed portion including a sidewall that defines a well that extends the length of the sidewall and wherein the well defines a well opening and is sized and shaped to receive and mount the release valve operably nested with the cam portion over the well opening; and
a valve adapter configured to releasably attach the coffee maker assembly to a rim of the cap assembly.

16. The system of claim 15, wherein the cam portion includes a handle attached to the cam portion to facilitate the manipulation by a user of relative rotation between the cam portion and the release valve.

17. The system of claim 15, wherein the reservoir container is configured to receive and house a basket-like member, and wherein the basket-like member extends into the reservoir container to a predetermined height above the bottom surface of the reservoir container, and wherein surfaces of the basket-like member are free form contact with an internal surface of the reservoir container.

18. The system of claim 17, wherein the basket-like member comprises a cone shaped reusable mesh filter.

19. The system of claim 15, wherein the container body may be made of any suitable material that allows for the storage of hot or cold liquids.
